(19) United States
(12) Patent Application Publication
(10) Pub. No.: US 2010/0229721 A1
(43) Pub. Date: Sep. 16, 2010

(54) Method of Controlling the Membrane Treatment of a Hydrogen Gas

(75) Inventor: Marie-Khuny Khy, Shanghai (CN)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/281,225

(22) PCT Filed: Feb. 9, 2007
(86) PCT No.: PCT/FR2007/050768

§ 371 Date: Aug. 29, 2008

(30) Foreign Application Priority Data
Mar. 1, 2006 (FR) 0650707

(51) Int. Cl. B01D 53/22

(52) U.S. Cl. 95/55

(57) ABSTRACT

The invention relates to a method of treating a gas comprising at least hydrogen and at least one other compound by means of a hydrogen-permeable separation membrane, in which the gas to be treated is brought into contact with the membrane so as to produce a hydrogen-enriched permeate and a hydrogen-depleted retentate. The differential pressure across the membrane is adjusted so that the ratio R of formula: in which Qr represents the flow rate of the retentate, Q represents the flow rate of the gas to be treated, F_{H2} represents a quantity characteristic of the hydrogen concentration of the gas to be treated and n is a decimal number strictly positive or negative, is equal to or greater than the value of the radio Rₘᵢₙ at which at least one compound present in the retentate condenses.

$$R = \frac{Qr}{Q} {( \frac{1}{{F}_{H 2}} )}^{n}$$

The present invention relates to a method for treating a gas containing hydrogen and other components, such as hydrocarbons, by using a membrane to separate the hydrogen therefrom.

In membrane permeation processes, the components of the gas mixture are separated by bringing the mixture into contact with a membrane. The membrane ensures the selective permeation of the components of the gas mixture across its wall. In the application of hydrogen-permeable membranes, the hydrogen (called “fast” gas) is separated from the other gas species (called “slow” gases) by the pressure difference between the gas mixture to be treated and the permeate of the membrane: this pressure difference acts as the driving force of the permeation.

These permeation processes are automatically controlled by various means according to the application (refining, syngas, etc.) and the type of gas mixture to be treated.

When the gas mixture to be treated contains hydrocarbons, in particular C₄₊ hydrocarbons, or other condensable compounds, these components are concentrated in the offgas or retentate, during permeation. The retentate dew point may then be very close to, or higher than, the membrane operating temperature, incurring a risk of condensation of these components on the fibers of the membrane or the premature deterioration of the performance of these fibers. This risk is directly related to the excessive quantity of hydrogen recovered in the permeation gas (or permeate). It is important to control the hydrogen recovery in the permeate to prevent the retentate from condensing in the membrane.

Systems for controlling membrane permeation processes have accordingly been developed. According to a first control system, either the pressure of the gas to be treated, or the pressure of the permeate, is controlled according to the variation in flow rate of the gas to be treated. When the flow rate of gas to be treated decreases, the hydrogen recovery increases and must then be controlled by increasing the pressure of the permeate or by decreasing the pressure of the gas to be treated. According to a second control system, the pressure of the permeate is controlled in order to maintain a setpoint corresponding to the ratio of the flow rate of retentate to the flow rate of gas to be treated (Qr/Q). The maintenance of this ratio at a sufficiently high level ensures an acceptable hydrogen recovery for any variation in flow rate of the gas to be treated Q, in order to maintain the retentate dew point at a constant value.

However, these two control systems fail to account for the fact that the gas composition of the gas to be treated may vary. Thus, if the gas to be treated suddenly becomes richer in hydrogen, the hydrogen permeation is promoted without the control system detecting this change in operating condition. In this case, the pressure is no longer appropriate and the dew point is liable to rise. On the contrary, if the gas to be treated becomes depleted of hydrogen, the risk of condensation is lessened, but the control system gives rise to hydrogen losses in the retentate.

It is therefore the object of the present invention to propose a method for controlling a hydrogen-selective membrane permeation of a gas containing hydrogen and compounds liable to condense in the membrane, said gas having a variable hydrogen concentration.

It is the object of the present invention to propose a method for controlling a hydrogen-selective membrane permeation of a gas containing hydrogen and compounds liable to condense in the membrane, said gas having a variable hydrogen concentration, in order to avoid the risk of condensation in the membrane.

It is the object of the present invention to propose a method for controlling a hydrogen-selective membrane permeation of a gas containing hydrogen and compounds liable to condense in the membrane, said gas having a variable hydrogen concentration, in order to avoid the risk of condensation in the membrane, while optimizing the hydrogen recovery.

For this purpose, the invention relates to a method for treating a gas comprising at least hydrogen and at least one other compound by means of a hydrogen-permeable separation membrane, in which the gas to be treated is brought into contact with the membrane so as to produce a hydrogen-enriched permeate and a hydrogen-depleted retentate, characterized in that the differential pressure across the membrane is adjusted so that the ratio R having the formula:

$$R = \frac{Qr}{Q} {( \frac{1}{{F}_{H 2}} )}^{n}$$

where:
Qr is the retentate flow rate,
Q is the flow rate of gas to be treated,
F_{H2} is a quantity characteristic of the hydrogen concentration in the gas to be treated,
n is a strictly positive or negative decimal number,
   is equal to or greater than the value of the ratio Rₘᵢₙ at which at least one compound present in the retentate condenses.

The invention therefore relates to a method for treating a gas comprising hydrogen and other compounds, said treatment consisting of bringing the gas into contact with a hydrogen-permeable separation membrane. The compounds other than hydrogen are compounds liable to condense in the retentate of the membrane: they may in particular be hydrocarbons or water. The gas to be treated by the membrane may, for example, be a wet syngas. The method is controlled by adjusting the differential pressure across the membrane, that is by adjusting the difference between the pressure of the gas to be treated upstream of the membrane and the pressure of the permeate downstream of the membrane. In practice, this differential pressure across the membrane can be adjusted by controlling the pressure of the permeate, preferably by means of a valve placed on the permeate line downstream of the membrane. It may also be adjusted by controlling the pressure of the gas to be treated, preferably by means of a valve placed upstream of the membrane. According to the invention, the differential pressure across the membrane is adjusted according to the value of the ratio R defined from the flow rates of retentate (Qr) and of gas to be treated (Q) and a characteristic quantity of the hydrogen concentration of the gas to the treated (F_{H2}). Thus, F_{H2} may be selected from the hydrogen concentration of the gas to be treated or the molar density of the gas to be treated. The exponent n in the formula of the ratio R depends on the type and surface area of the membrane, the type of gas to be treated, and anticipated operating situations conditioned by the upstream process. The exponent n may be positive or negative according to the type of quantity F_{H2}. For each membrane used and each gas to be treated used, the value of the exponent n is fixed by taking the following steps:

a—determination of the maximum temperature T_{Max} of the dew point of the retentate usable in the membrane,
b—for various types of gas to be treated having flow rates Q and different characteristic quantities of hydrogen concentration F_{H2}, determination of the optimal retentate flow rate Qr whereby the differential pressure across the membrane can be maximized while keeping the dew point of the retentate T lower than T_{Max},
c—calculation of the value n whereby the dew point T can be correlated with the values of R for the various types of gas examined in step b.

In the context of the present invention, “correlate” means establishing a relation between R and the dew point T so that they vary as a function of one another. In practice, it may be more expeditious to assign integer values to n to find the correlation. However, in order to have a refined value of the exponent n, it is preferable to assign it decimal values.

Once the formula of the ratio R is determined, for the implementation of the inventive method, the differential pressure across the membrane is adjusted so that the ratio R is equal to or higher than the ratio Rₘᵢₙ at which at least one compound present in the retentate condenses. The value of Rₘᵢₙ corresponds to the operating point of the membrane below which at least one compound present in the retentate condenses. The value of Rₘᵢₙ is fixed from the correlation established between Rₘᵢₙ and T (step c).

Preferably, the differential pressure across the membrane is adjusted so that the ratio R is equal to the ratio Rₘᵢₙ.

The method according to the invention is particularly suitable for treating a gas comprising hydrocarbons having more than 4 carbon atoms.

The use of the ratio R in the inventive method serves to automatically adapt the operating conditions to the various gases to be treated, on the one hand to forestall the risk of condensation in the membrane and on the other to maintain the hydrogen recovery at its optimal value. If the load conditions change during operation (lower flow rate of gas to be treated, gas to be treated more or less hydrogen-rich), the maintenance of the ratio R at its setpoint Rₘᵢₙ maintains the hydrogen recovery, while preserving a safety margin on the condensation of the retentate.

It is known that after several years of operation, the polymer fibers constituting the membrane lose their separation efficiency. The regulation of the inventive method by the ratio R has the advantage of eliminating the influence of this aging on the hydrogen recovery. If the fibers are less efficient over time, maintenance of the ratio at the same initial setpoint Rₘᵢₙ guarantees the hydrogen recovery.

### EXAMPLE

The gas to be treated issues from a refinery hydrotreating purge and contains hydrogen and hydrocarbons in more or less variable contents according to the operations of the upstream units, with variable throughputs.

Table 1 gives various compositions that the gas to be treated may have during the implementation of the permeation process. According to the prior art, if the hydrogen-selective permeation process is implemented adapted to the treatment of cases 1 and 2 with the gas of case 3, condensation of the retentate in the membrane is observed.

TABLE 1

| | Case 1 | Case 2 | Case 3 |
|---|---|---|---|
| Composition (%) | | | |
| H₂ | 82 | 88 | 94 |
| C₁ | 13 | 8 | 4 |
| C₂ | 3 | 2 | 1 |
| C₃ | 1 | 1 | 0.4 |
| iC₄ | 0.3 | 0.2 | 0.1 |
| nC₄ | 0.2 | 0.2 | 0.1 |
| iC₅ | 0.3 | 0.3 | 0.0 |
| nC₅ | 0.0 | 0.0 | 0.0 |
| C₆₊ | 0.1 | 0.2 | 0.3 |
| H₂O | 0.1 | 0.1 | 0.1 |
| Flow rate Q (Nm³/h) | 11500 | 11400 | 7500 |
| Flow rate (kg/h) | 2870 | 2320 | 1130 |
| Temperature (° C.) | 65 | 43 | 91 |
| Molecular weight (g/mol) | 5.6 | 4.6 | 3.4 |
| Hydrocarbon dew point (° C.) | 42 | 42 | 42 |
| H₂O dew point (° C.) | 42 | 42 | 42 |

To calculate the value of n in the formula of the ratio R necessary for controlling the permeation method according to the invention, the operating conditions of the method avoiding the condensation of the retentate in the membrane, while maximizing the hydrogen recovery, are determined. With the membrane operating at 90° C., the retentate dew point must not exceed 80° C. (Tₘₐₓ) (step a). In the three cases, the differential pressure across the membrane is varied by adjusting the pressure of the permeate, in order to maximize the hydrogen recovery while preventing the dew point of the retentate from reaching 80° C. (step b). For the above three cases, the optimal operating conditions (dew point lower than 80° C. and maximized hydrogen recovery) are identified in Table 2.

TABLE 2

| | Case 1 | Case 2 | Case 3 |
|---|---|---|---|
| Flow rate of gas to | 11 500 | 11 400 | 7500 |
| be treated Q (Nm³/h) | | | |
| H₂ content of gas to | 82 | 88 | 94 |
| be treated (mol %) | | | |
| Differential | Maximum: 67 | Maximum: 67 | Reduced: 35 |
| pressure (bar) | | | |
| Retentate flow rate | 2110 | 1340 | 1180 |
| Qr (Nm³/h) | | | |
| Retentate dew point | 47 | 67 | 80 |
| T (° C.) | | | |
| Qr/Q | 0.183 | 0.117 | 0.157 |

The ratio

$$R = \frac{Qr}{Q} {( \frac{1}{{F}_{H 2}} )}^{n}$$

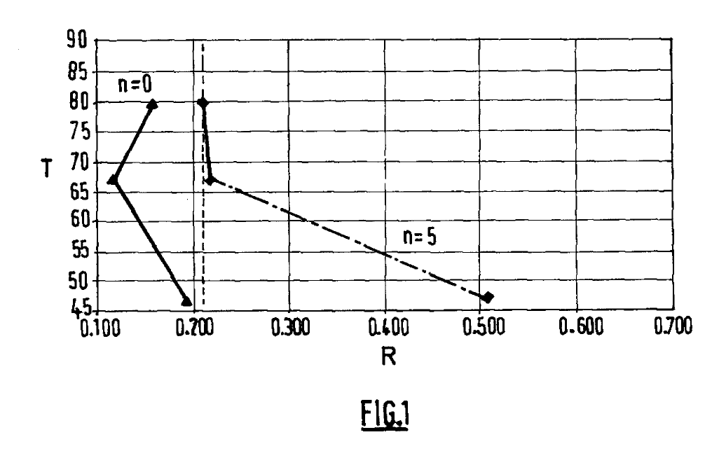

is calculated for the above three cases, by successively using the values of 0, 1, 2, . . . for n in the formula (step c). No relationship between R and the dew point is observed for n between 1 and 4. On the contrary, for n=5, R and the dew point are correlated. This correlation appears in FIG. 1, which shows that the higher the ratio R, the lower the dew point T.

To fix the setpoint of the method, the value of Rₘᵢₙ is evaluated for which the temperature T is not more than 80° C. (Tₘₐₓ). In the example shown, Rₘᵢₙ is 0.21.

In consequence, the membrane is used to treat the hydrogen-containing gas issuing from the hydrotreating purge of the refinery by adjusting the differential pressure across the membrane so that the ratio R having the formula:

$$R = \frac{Qr}{Q} {( \frac{1}{{F}_{H 2}} )}^{5}$$

is always higher than 0.21.

This prevents the condensation of the compounds of the retentate in the membrane while offering a maximum hydrogen recovery.

1-7. (canceled)

8. A method for treating a gas comprising at least hydrogen and at least one other compound, comprising the steps of:
bringing the gas into contact with a hydrogen-permeable separation membrane thereby producing a hydrogen-enriched permeate and a hydrogen-depleted retentate; and
adjusting a differential pressure across the membrane is adjusted so that a ratio R is equal to or greater than the value of a ratio Rₘᵢₙ, wherein R has the formula:
$$R = \frac{Qr}{Q} {( \frac{1}{{F}_{H 2}} )}^{n}$$
where:
Qr is the retentate flow rate,
Q is the flow rate of gas to be treated,
F_{H2} is a quantity characteristic of a hydrogen concentration in the gas to be treated,
n is a strictly positive or negative decimal number,
and Rₘᵢₙ represents the ratio R in which at least one of the at least one other compound present in the retentate condenses.

9. The method of claim 8, wherein the differential pressure across the membrane is adjusted by controlling a pressure of the permeate.

10. The method of claim 8, wherein the differential pressure across the membrane is adjusted by controlling the pressure of the gas to be treated.

11. The method of claim 8, wherein F_{H2} is a quantity selected from the group consisting of a hydrogen concentration of the gas to be treated and a molar density of the gas to be treated.

12. The method of claim 8, wherein the value of the exponent n in the formula of the ratio R is fixed by taking the following steps:
a) determining a maximum temperature T_{MaX} of the dew point of the retentate usable in the membrane;
b) for various types of the gas to be treated having flow rates Q and different characteristic quantities of hydrogen concentration F_{H2}, determining an optimal retentate flow rate Qr whereby the differential pressure across the membrane is maximized while keeping the dew point of the retentate T lower than T_{Max},
c) calculation of the value n whereby the dew point T can be correlated with the values of R for the various types of the gas for which an optimal retentate flow rate Qr was determined in said step b.

13. The method of claim 8, wherein the differential pressure across the membrane is adjusted so that the ratio R is equal to the ratio Rₘᵢₙ.

14. The method of claim 8, wherein the at least one other compound comprises one or more hydrocarbons having more than 4 carbon atoms.

15. The method of claim 8, wherein the differential pressure across the membrane is adjusted by controlling a pressure of the permeate with a valve placed on a permeate line downstream of the membrane.

16. The method of claim 8, wherein the differential pressure across the membrane is adjusted by controlling the pressure of the gas to be treated with a valve placed upstream of the membrane.
